(19) United States
(12) Patent Application Publication
(10) Pub. No.: US 2002/0142729 A1
(43) Pub. Date: Oct. 3, 2002

(54) Method for identifying a system state of a technical system with a sensor device having a passive component, as well as a sensor device and use of a sensor device

(75) Inventor: Alfred Pohl, Mistelbach (AT)

Correspondence Address: SUGHRUE MION, PLLC, 2100 Pennsylvania Avenue, NW, Washington, DC, 20037-3213, US

(73) Assignee: SIEMENS AG

(21) Appl. No.: 10/109,840

(22) Filed: Apr. 1, 2002

(30) Foreign Application Priority Data
Mar. 30, 2001 (EP) 01108172.6
Mar. 30, 2001 (DE) 20105592.9

(51) Int. Cl. H04B 17/00

(52) U.S. Cl. 455/67.1; 455/67.3

(57) ABSTRACT

A method, as well as an associated sensor device and use of such method, for identifying a system state of a technical system (7) by a sensor device with an antenna element (1; 10) for receiving and transmitting radio signals (13; 14) to detect and communicate the system state. The transmission behavior of the antenna element is determined by controlling at least one load impedance (8) of the antenna element. The load impedance of the antenna element is controlled by a physical signal (6).

This application claims priority from European Patent Application EP 011 08 172.6, filed on Mar. 30, 2001, and from German Utility Model Application DE 201 05 592.9, filed on Mar. 30, 2001. Both of these priority applications are incorporated in full into the present application by reference.

### FIELD OF AND BACKGROUND OF THE INVENTION

The present invention relates to a method for identifying a system state of a technical system. The invention further relates to a sensor device with an antenna element, as well as to the use of such a sensor device.

Radio identification systems in which a transmitted radio signal is reflected by a receiving antenna are known in the art. The load impedance of the receiving antenna is influenced via active components, so that the radio signal reflected by the receiving antenna is modulated compared to the transmitted radio signal. The active components of the load impedance of the receiving antenna are controlled accordingly via a control circuit with a power supply.

### OBJECTS OF THE INVENTION

One object of the present invention is to provide a method for identifying a system state of a technical system, using a receiving antenna that is simple in its design and does not require a power supply. A further object of the invention is to provide an improved sensor device with an antenna element, as well as provide uses of such a sensor device.

### SUMMARY OF THE INVENTION

According to one formulation, the invention provides a method for identifying a system state of a technical system by a sensor device, which includes detecting and communicating the system state with antenna elements for receiving and transmitting radio signals. The transmission behavior of the antenna elements is regulated by controlling at least one load impedance of the antenna elements. The load impedance of the antenna elements is controlled by a physical signal. According to another formulation, the invention provides a sensor device that includes antenna elements receiving and transmitting radio signals, and a load impedance for one of the antenna elements. The transmission behavior of the one antenna element is regulated by controlling the load impedance, the load impedance being a passive component controlled by a physical signal.

In the method according to the invention, the load impedance of the reflecting antenna element is controlled by an additional physical signal, whereby the transmission behavior (reflection behavior) of the reflecting antenna element is controlled. Thus, the radio signals transmitted by the evaluating antenna element are modulated differently by the physical signal, as a function of the type of control of the load impedance, and are returned by the reflecting antenna element to the evaluating antenna element for evaluation.

In the method according to the invention, no separate power supply is required for the reflecting antenna element and its load impedance. This greatly improves the applicability and versatility of the inventive method. In an advantageous refinement of the method, the reflecting antenna element receives at least one and preferably two mono-frequency and high-frequency radio signals from the evaluating antenna element. These signals are then modulated by the reflecting antenna element, particularly with a main band region and one or more sideband regions, and are returned to the evaluating element. If two radio signals are received, several sideband regions are present at relatively large intervals, thereby improving the quality of the evaluation. By evaluating the radio signal returned by the reflecting antenna element in an evaluation unit of the evaluating antenna element, conclusions can be drawn regarding the control by the physical signal of the load impedance of the reflecting antenna element. It is additionally possible to draw conclusions regarding the signal size of the physical signal or regarding additional control or influencing variables.

If the additional physical signal, prior to reaching the reflecting antenna element, interacts with a technical system and is thereby changed, conclusions can be drawn regarding the type of the interaction with said technical system in connection with the radio signal returned by the reflecting antenna element, if the signal size of the physical signal upon transmission is known. This makes it possible to determine the system states of the technical system. The term “technical system” should be understood in a general sense and may refer to a component to be checked or detected, a production item, a test object, or generally an item of merchandise.

The physical signal can be transmitted by a transmitter, which is connected to an evaluation unit of the evaluating antenna element. With this arrangement, both the signal data of the transmitted and returned (modulated) radio signal as well as the signal size of the physical signal upon transmission are available in the evaluation unit and can be jointly evaluated.

In one variant of the method, the physical signal can be a light signal. In interacting with a technical system introduced into the transmission path of the physical signal, the light signal can be used, for instance, to determine the light permeability or the reflection behavior of the technical system. When the light signal interacts with the technical system, a change occurs particularly in the amplitude, frequency and/or phase of the light signal, which correspondingly controls the load impedance of the reflecting antenna element. Using a light signal as the physical signal makes it possible, for instance, to determine whether a manufactured glass pane is provided with a uniform coating.

In a further variant of the method, the physical signal can be a magnetic signal, which in interaction with the corresponding technical system can be used to determine particularly the magnetic properties of the technical system (e.g. the degree of magnetization). A magnetic signal can be used, for instance, to determine whether the technical system comprises magnetic materials.

In a further variant of the method, the physical signal can be a force signal. This force signal can be produced by dynamic loading of the technical system and can thus be used to draw conclusions regarding the loading behavior of the technical system. A force signal can be used, for instance, to determine response variables of an automobile tire as the technical system in braking tests or acceleration tests.

The method according to the invention can also be used with several (and different) physical signals to determine a plurality of system states of a technical system. For instance, a light signal and a magnetic signal can be used in tandem as the physical signals to interact with the corresponding technical system and to control the load impedance of the reflecting antenna element.

The output signals of the load impedance of the reflecting antenna element can be supplied to the reflecting antenna element either directly or via a converter device for converting an output value of the load impedance into either an impedance or a voltage for controlling an impedance.

The inventive sensor device with an antenna element to receive and transmit radio signals for detecting and communicating a system state of a technical system includes, as a load impedance of the reflecting antenna element, a passive component which is controlled by a physical signal and does not require a separate power supply.

As a function of the type of the physical signal, the passive component can be embodied as a light-sensitive impedance, e.g. as an LDR element (light dependent resistor) or as a phototransistor. A passive component embodied as a magneto-sensitive element can be configured as a GMI element (giant magneto impedance) or a GMR element (giant magneto resistor).

If the passive component is a force-sensitive element, it can be configured, for instance, as a piezo element or as a pressure cell, whose output values depend on the acting loads. A plate capacitor whose plate spacing changes as a function of load can also be used as a force-sensitive element.

The physical signal can also be an acoustic signal. In this case, for instance, a capacitor microphone can be used as a force-sensitive or sound pressure-sensitive component.

In a further embodiment of the sensor device, several passive components may be provided as load impedances of the reflecting antenna element, so that different physical signals, for instance a light signal and a magneto-sensitive signal, can be received.

The output quantities of the passive component(s) can be connected to the reflecting antenna element either directly or via a converter device, to control the reflection behavior of the antenna element. Such converter devices can, for instance, be embodied as field effect transistors (FETs) or as variable capacitance diodes, which are controlled by the output voltage of the piezo element.

### BRIEF DESCRIPTION OF THE DRAWINGS

The invention and advantageous refinements thereof will now be described in greater detail with reference to exemplary embodiments depicted in the drawing figures in which:

FIG. 1 is a schematic diagram of a signal exchange between an evaluating and a reflecting antenna element and

FIG. 2 is a schematic diagram of a frequency spectrum of a transmitted signal and a modulated reflected signal.

### DETAILED DESCRIPTION OF THE PREFERRED EMBODIMENTS

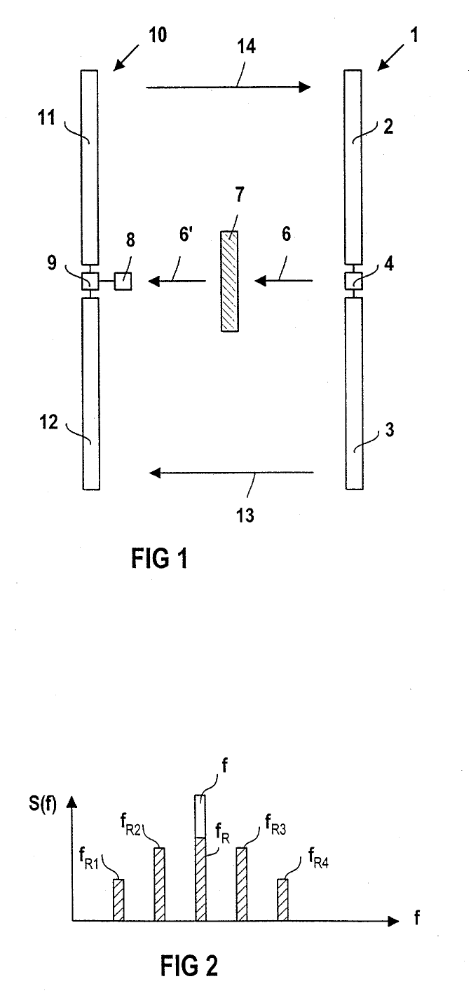

FIG. 1 shows an evaluating antenna element 1 with radiator halves 2, 3 and an evaluation unit 4. The figure further depicts a reflecting antenna element 10 with radiator halves 11, 12, which are connected via a converter device 9 to a load impedance 8 as the base point resistance of the antenna element 10. Radio signals 13 transmitted by the evaluating antenna element 1 are reflected as a function of a control (modification) of the load impedance 8 through the resulting reflection behavior of reflecting antenna element 10 via correspondingly modulated reflected radio signals 14 for evaluation in the evaluation unit 4 of the antenna element 1.

The load impedance 8 of the reflecting antenna element 10 is embodied, for instance, as a light-, magneto- or force-sensitive element, so that the load impedance 8 is modified by at least one physical signal 6, e.g. a light signal, a magnetic signal, and/or a force signal. In an alternative embodiment not specifically illustrated, the load impedance 8 can also be integrated in the technical system 7, e.g. as a piezo element, such that a change occurs in the load impedance 8 if the technical system 7 is deformed (by a force signal).

The physical signal 6, prior to reaching the load impedance 8, interacts with the technical system 7. If the technical system 7 is, for instance, a glass pane, a light signal, as the physical signal 6, can penetrate the technical system 7 and thereby change its signal properties, e.g. its amplitude. The signal 6, whose signal properties are accordingly altered following interaction with the technical system 7 (see signal 6′), now reaches the load impedance 8 and modifies it. As a result, radio signals, which are, for instance, continuously transmitted by the evaluating antenna element 1, are returned by the reflecting antenna element 10 to the evaluating antenna element 1 as correspondingly changed and modulated returned (reflected) radio signals 14, due to the changed reflection behavior of the reflecting antenna element 10 that results from the modified load impedance 8.

If the evaluating antenna element 1 continuously transmits, in particular, mono-frequency and high-frequency radio signals 13 for reflection by the reflecting antenna element 10, specific spatially limited and/or time-limited trigger signals of the physical signal 6 can be used to achieve a change of limited duration in the load impedance 8 due to the interaction of the signal 6 with the technical system 7. Based on accordingly altered, modulated radio signals 14 returned by the reflecting antenna element 10 to the evaluating antenna element 1, conclusions can then be drawn in an evaluation unit 4 regarding defined properties of the technical system 7.

To avoid interference by neighboring identification systems, the signal 6 can have uncorrelated signal sequences (trigger sequences and/or different trigger frequencies) and/or a signal code. By specific transmission of signals 6 (trigger signals), e.g. via a transmitter (not shown), a one-bit identification of a system state of the technical system 7 can take place.

The output of the load impedance 8 can—according to an embodiment not shown—be connected directly to the radiator halves 11, 12 of the reflecting antenna element 10 or can—as depicted in FIG. 1—be connected to the radiator halves 11, 12 via a converter device 9. This converter device 9 can convert an output quantity of the load impedance 8 into an impedance or a voltage, so that interconnecting the load impedance 8 and the converter device 9 creates a passive sensor with wireless readout for physical or chemical measured values of the system states of the technical system 7.

FIG. 2 is a frequency diagram (power density S (f) as a function of frequency f) of a radio signal 13 with a frequency f, transmitted by an evaluating antenna element 1 (cf. FIG. 1). A radio signal 14 reflected by a reflecting antenna element 10 has a reflection frequency f_{R}, which corresponds essentially to the transmission frequency f. Moreover, additional reflection frequencies f_{R1} to f_{R4} appear in sidebands of the reflected radio signal 14. While the transmitted radio signal 13 of the evaluating antenna element 1 is thus found in a narrow main band region, the reflected radio signal 14 of the reflecting antenna element 10 also includes frequency components f_{R1}-f_{R4} in sideband regions, so that there is no interference, or only very minor interference, of the reflected radio signal 14 by the transmitted radio signal 13. By evaluating the frequency components f_{R1}-f_{R4} in the sidebands of the reflected radio signal 14 in the evaluation unit 4 of the evaluating antenna element 1, conclusions can be drawn regarding a change in the signal properties of the signal 6 through interaction with the technical system 7—and thus conclusions regarding the system properties of the technical system 7.

The above description of the preferred embodiments has been given by way of example. From the disclosure given, those skilled in the art will not only understand the present invention and its attendant advantages, but will also find apparent various changes and modifications to the structures and methods disclosed. It is sought, therefore, to cover all such changes and modifications as fall within the spirit and scope of the invention, as defined by the appended claims, and equivalents thereof.

What is claimed is:

1. Method for identifying a system state of a technical system by a sensor device, comprising:
detecting and communicating the system state with antenna elements for receiving and transmitting radio signals;
regulating the transmission behavior of the antenna elements by controlling at least one load impedance of the antenna elements, and
controlling the load impedance of the antenna elements by a physical signal.

2. Method as claimed in claim 1,
wherein said detecting and communicating comprises receiving a high-frequency radio signal via the antenna elements.

3. Method as claimed in claim 1,
wherein said detecting and communicating comprises receiving a mono-frequency radio signal via the antenna elements.

4. Method as claimed in claim 1,
wherein said detecting and communicating comprises receiving a mono-frequency radio signal and transmitting a radio signal with a main band region and several sideband regions by the antenna elements.

5. Method as claimed in claim 1,
wherein signal properties of the physical signal change on a transmission path of the physical signal.

6. Method as claimed in claim 1,
wherein a light signal is transmitted as the physical signal.

7. Method as claimed in claim 6,
wherein at least one of an amplitude, a frequency and a phase of the light signal changes on a transmission path of the light signal.

8. Method as claimed in claim 1,
wherein a magnetic signal is transmitted as the physical signal.

9. Method as claimed in claim 8,
wherein at least one of an amplitude, a frequency and a phase of the magnetic signal changes on a transmission path of the magnetic signal.

10. Method as claimed in claim 1,
wherein a force signal is transmitted as the physical signal.

11. Method as claimed in claim 10,
wherein at least one of an amplitude, a frequency and a phase of the force signal changes on a transmission path of the force signal.

12. Method as claimed in claim 1,
further comprising supplying an output signal of the load impedance to the antenna elements via a converter device.

13. Sensor device, comprising:
antenna elements receiving and transmitting radio signals; and
a load impedance of one of the antenna elements,
wherein the transmission behavior of the one antenna element is regulated by controlling at least the load impedance, and
wherein the load impedance is a passive component controlled by a physical signal.

14. Sensor device as claimed in claim 13,
wherein the load impedance is a light-sensitive element.

15. Sensor device as claimed in claim 14,
wherein the light-sensitive element is an LDR element or a phototransistor.

16. Sensor device as claimed in claim 13,
wherein the load impedance is a magneto-sensitive element.

17. Sensor device as claimed in claim 16,
wherein the magneto-sensitive element is a GMI element or a GMR element.

18. Sensor device as claimed in claim 13,
wherein the load impedance is a force-sensitive element.

19. Sensor device as claimed in claim 18,
wherein the force-sensitive element is a piezo element.

20. Sensor device as claimed in claim 13,
further comprising a converter device transmitting output signals of the load impedance to the one antenna element.

21. Sensor device as claimed in claim 20,
wherein the converter device is a field effect transistor.

22. Sensor device as claimed in claim 20,
wherein the converter device is a variable capacitance diode.

23. A method, comprising:
transmitting a radio signal from a first element;
transmitting a further signal, at least one signal property of which is altered upon interaction of the signal with a test subject;
receiving the altered signal with a load impedance that operates without active components;
outputting a reaction of the load impedance to the altered signal to a second element;
reflecting the radio signal from the second element as a reflected radio signal modulated by the reaction output to the second element; and
evaluating the reflected radio signal.

24. The method according to claim 23,
wherein the further signal is transmitted in a time interval that is during and that is less than a time duration in which the radio signal is transmitted.

25. The method according to claim 23,
wherein the further signal has an uncorrelated signal sequence or a signal code.

26. A device, comprising:
a first antenna element transmitting a radio signal;
a source that outputs a physical signal having a signal property that is altered by interaction with an evaluation subject;
a passive load impedance that produces an output in response to the altered physical signal;
a second antenna element that reflects the radio signal modulated in accordance with the output of the passive load impedance; and
an evaluation unit that processes the reflected radio signal.

27. The device according to claim 26, further comprising a converter device that converts the output of the passive load impedance into a converted output supplied to the second antenna element.
